(19) United States
(12) Patent Application Publication
(10) Pub. No.: US 2020/0019415 A1
(43) Pub. Date: Jan. 16, 2020

(54) USER TERMINAL, USER INTERFACE, COMPUTER PROGRAM PRODUCT, SIGNAL SEQUENCE, MEANS OF TRANSPORT, AND METHOD FOR SETTING UP A USER INTERFACE OF A MEANS OF TRANSPORT

(71) Applicant: VOLKSWAGEN AKTIENGESELLSCHAFT, Wolfsburg (DE)

(72) Inventors: Astrid KASSNER, Berlin (DE); Joel ROZADA, Göteborg (SE); Fredrik ANDRESEN, Kållered (SE)

(21) Appl. No.: 16/471,666

(22) PCT Filed: Dec. 22, 2016
(86) PCT No.: PCT/EP2016/082393

§ 371 Date: Jun. 20, 2019

(51) Int. Cl. G06F 9/451; H04L 29/08

(52) U.S. Cl. CPC G06F 9/451; H04L 67/34

(57) ABSTRACT

A user terminal, a user interface for a transportation vehicle, a computer program product, a signal sequence, a transportation vehicle, and a method for influencing a user interface of a transportation vehicle. The method includes determining a user input for setting up a representation on the user interface of the transportation vehicle by a user terminal, establishing a data communication link between the user terminal and the transportation vehicle and/or between the user terminal and a server, and setting up the user interface of the transportation vehicle according to the representation on the user interface.

### PRIORITY CLAIM

This patent application is a U.S. National Phase of International Patent Application No. PCT/EP2016/082393, filed 22 Dec. 2016, the disclosure of which is incorporated herein by reference in its entirety.

### SUMMARY

Illustrative embodiments relate to a user terminal, a user interface, a computer program product, a signal sequence, as well as a transportation vehicle and a method for setting up a user interface of a transportation vehicle. Disclosed embodiments relate to a convenient and flexible way of setting up a user interface of the transportation vehicle.

### BRIEF DESCRIPTION OF THE DRAWINGS

Exemplary embodiments are described with reference to the attached drawings. Shown are:

FIG. 1 shows a schematic drawing of a situation of a user, who by an exemplary embodiment of a disclosed user terminal is exerting control over an exemplary embodiment of a disclosed user interface of an exemplary embodiment of a disclosed transportation vehicle; and

FIG. 2 shows a flow chart illustrating operations of an exemplary embodiment of a disclosed method for configuring a user interface of a transportation vehicle.

### DETAILED DESCRIPTION

Modern forms of user interface for transportation vehicle increasingly resemble those found in hand-held mobile user terminals or the screen displays of desktop PCs. For example, home screen comprising icons representing applications (“apps”) are used so as to produce as flat as possible a hierarchy of functions of the transportation vehicle. This results in means for the user-specific adaptation of a layout of the screen views of the interaction menu. If the user (in particular, a driver) sits in the transportation vehicle, he/she often has a (more or less urgent) destination and therefore little free time available to configure the user interface. The same applies to any software-based extensible functionalities of the transportation vehicle, which the user can only perform by (occasionally) neglecting their driving task during the journey. Disclosed embodiments allow a user interface of a transportation vehicle to be configured in a more convenient and safe manner.

Disclosed embodiments provide a method for configuring a user interface of a transportation vehicle. The user interface can comprise, for example, a color display screen, which can act as a central control element of a plurality of vehicle functions. Such display screens are also referred to as a CID (Central Information Display) and are usually located in a central position of the instrument dashboard. The transportation vehicle can be, for example, a passenger car, mini-van, truck, motorcycle, air- and/or water-borne vehicle. In a first operation, a user input is determined for configuring a visual representation of the user interface of the transportation vehicle by a user terminal. For example, the user terminal can be a mobile device and used for data communication. For example, it can also be designed as a smartphone, tablet, or similar. The representation of the user interface can be a visual reproduction, or at least a schematic structure (“a breakdown of the information displays of the user interface of the transportation vehicle”). Optionally, the user input can take place offline, i.e., without any direct connection or manipulation of the configuration of the user interface. The user input can therefore represent a change in the user interface that will be saved. The modification of the representation can represent a definition, an appearance and/or functionality of the user interface. In other words, the user influences the form and the virtual functionality (a definition of functions which are not really executable in the representation itself) of the representation and therefore defines a real functionality and a visual layout of the user interface of the transportation vehicle in advance. Then, a data communication connection is established between the user terminal and the transportation vehicle, which can be carried out by wired or wireless means. For example, a terrestrial mobile radio/data communication connection can be produced (in particular, mediated by the internet). Alternatively or additionally, a data communication connection (also wired or wireless) can be established between the user terminal and a server (e.g., via the internet). Subsequently, or in response thereto, the user interface of the transportation vehicle can be configured automatically in accordance with the representation of the user interface. In other words, the settings made with reference to the representation of the user interface are automatically valid for the user interface also. For example, a sequence of user inputs, in the way in which they were “adopted” with regard to the representation, is automatically transmitted to the user interface one after the other. Since the representation of the user interface on the mobile user terminal can be performed under completely different conditions than during the journey in the transportation vehicle, a deeper engagement with the representation by the user is possible and therefore a more appropriate adaptation of the representation to the user's needs, since this process can be carried out using the user interface of the transportation vehicle. The modification of the representation of the user interface can be carried out on the user terminal using completely different input devices (e.g., a touchscreen) and/or input gestures (e.g., swiping gestures, sustained pressure gestures, pinch/spread) and thus more conveniently than is possible using the user interface of the transportation vehicle, assuming that the same does not support the corresponding input gestures or does not have the appropriate hardware. Also, a more in-depth research into appropriate functions and corresponding applications can be carried out on the mobile user terminal in non-driving mode. Overall, this results in a more convenient and safe way of manipulating the configuration of a user interface of a transportation vehicle.

While the above-mentioned operations can represent a disclosed procedure by using a mobile phone of the user, a method is described in the following which can be carried out, for example, by a user interface of a transportation vehicle and/or using a transportation vehicle. Accordingly, a method is proposed for setting up a user interface of a transportation vehicle by a user by a user terminal. For example, the user terminal can be a data communication terminal of a user. It can be implemented as a laptop, desktop PC, smartphone, tablet, etc. and/or be used for wireless communication. The above comments apply in an appropriate way to the transportation vehicle and the user interface. In a first operation, a data communication connection (wireless or wired) is established between the transportation vehicle and the user terminal and/or between the transportation vehicle and a server. The server can be a server of a manufacturer of the transportation vehicle/the user interface or its operating system, or of an operator of the transportation vehicle, or similar. At a later time or in response thereto, a dataset which is created using an application of the user terminal is received, which defines a representation of the user interface. The representation can be a visual and/or a functional representation of the user interface of the transportation vehicle. Then, the user interface of the transportation vehicle is automatically configured based on the dataset in accordance with the representation of the user interface. In other words, the dataset created on the user terminal device (offline or online) is transmitted to the transportation vehicle at a later time and the dataset or the information in the representation of the user interface is used to modify the user interface with regard to its appearance and/or functionality. The features, feature combinations and the benefits resulting from this second disclosed embodiment correspond in such an obvious way to those of the first disclosed embodiment that, to avoid repetition, reference is made to the above comments.

To prevent unauthorized use of the application for configuring the representation, an authorization can be requested (e.g., by entering secret codes and/or by using a cable). This may be a prerequisite for a modification of the representation and/or for a transmission of a dataset corresponding to the representation to the transportation vehicle or to an Internet-based web server. Alternatively or additionally, the data communication connection between the user terminal and the transportation vehicle can be established via an access to a web portal, which is logically linked to the transportation vehicle. In other words, the application can be assigned to a user profile in a web-based portal of the manufacturer of the transportation vehicle or of the user interface or its operating system, by virtue of access data and/or a user profile being stored in the application. Of course, the access data can also be input by the user case-by-case. Only in the event that the web portal performs a successful authorization of the data communication connection with the application is it then possible for the user interface of the transportation vehicle to be configured on the basis of the dataset. Thus, an erroneous or even improper use of the application can be effectively prevented.

The configuration can comprise an arrangement of icons representing applications on a home screen of the user interface. In other words, the user can manage the relative arrangement of the application icons using swiping gestures (e.g., drag and drop). Alternatively or additionally, when manipulating the representation the user can define applications to be downloaded. In other words, the user specifies which applications the transportation vehicle should download and/or (re)install in its own operating system at the next opportunity. The user can instruct the representation to set up the applications to be downloaded in a predefined way after their successful installation. For example, user data from an application of the user terminal can also be used for the newly downloaded application. The representation can also be instructed to download an application that is also installed on the user's terminal and personally configured by the user, and also to configure this in the user interface of the transportation vehicle in accordance with the configuration of the application on the user's terminal. In the absence of a dictation function and/or a fully-fledged keyboard, the configuration of freshly downloaded applications can thus be carried out much more simply and conveniently.

To extend the functionality of the user interface of the transportation vehicle a data communication connection (wired or wireless) can be established between the transportation vehicle and an application server (for example, internet-based, in particular, from a manufacturer of the transportation vehicle or some software of the user interface). The data communication connection can be set up, for example, by the user terminal and/or the application which is used to manipulate the representation of the user interface. Alternatively or additionally, the data communication connection can be set up automatically the next time it is used (access, starting, driving, charging operation etc.) in relation to the transportation vehicle. As soon as the data communication link is established and, in response thereto, an application defined in the representation can be loaded into the transportation vehicle via the data communication connection, or at least be updated using the data communication connection. This ensures that a visual and/or functional configuration of the representation is carried out as quickly as possible.

It is possible that a manipulation of the user interface of the transportation vehicle is not carried out immediately in response to the configuration of the representation of the user interface. Instead, a dataset defining the representation can be uploaded onto an (e.g., stationary and/or internet-based) server by the user terminal. Thereafter, the data communication connection between the user terminal and the server is terminated. Until a second data communication connection is set up between the server and the transportation vehicle, in particular, seconds, minutes, hours or even days or weeks may elapse. In the meantime, a permission of the user or the user's application to manipulate the user interface of the transportation vehicle may be denied. In other words, the user is not authorized (for example, due to a use of the transportation vehicle by another user) to design the user interface of the transportation vehicle. After (re-)authorization of the user for access to the transportation vehicle and its on-board electrical systems (e.g., due to a rehiring or change of ownership of the vehicle, which might be a pool car or car-sharing vehicle), the dataset can be downloaded from the server onto the transportation vehicle and used there to configure the user interface.

In the case that a comparatively long (predefined) period of time has elapsed between the manipulation of the representation by the user and the downloading of the dataset onto the transportation vehicle, a query can be issued to the user in advance as to whether he/she (still) agrees to a manipulation of the form/functionality of the user interface. For example, the user may find the transportation vehicle in a condition which has been defined by a previous user. If the user in question is happy with the structure/functionality of the user interface of the transportation vehicle defined by the previous user, he/she can even block their own predefined data set from affecting the user interface by terminating/prohibiting this synchronization.

The user interfaces and/or transportation vehicle to be configured can preferably be in series production. In other words, the transportation vehicle described here are the property of a customer. In other words, the disclosed method may be excluded from being a development tool which developers/testers would use to perform field trials with vehicles that are not the property of a customer.

According to a third disclosed embodiment, a user terminal (such as a smartphone, a tablet, a desktop PC or a laptop) for configuring a user interface of a transportation vehicle is proposed. The user terminal comprises a user interface (for example, a touchscreen, buttons, sliders, a mouse, a keyboard or a microphone, which can be used as a voice input), an evaluation unit (e.g., a microcontroller, a programmable processor, an electronic control unit, or similar) and a transmitter/receiver unit, which can have, for example, a mobile communication module, a BLUETOOTH® module, a USB socket, or similar. The evaluation unit is configured, in connection with the user interface, to determine a user input into an application (preferably to be executed offline) for configuring a representation of an (e.g., visual) user interface of a transportation vehicle. The configuration may define or modify a definition, appearance or set of functions of the user interface. The evaluation unit is configured, in connection with the transmitter/receiver unit, to establish a data communication connection (wireless or wired) to the transportation vehicle and/or to a stationary server for transmission of a dataset which defines the representation, and then to transmit the dataset to the transportation vehicle. In other words, the user terminal is configured to realize the features, feature combinations and the resulting benefits of the embodiments described above in such an evidently similar manner that to avoid repetitions, reference is made to the above comments. The operations to be carried out by the user in this process are supported or performed by the user terminal.

According to a fourth disclosed embodiment, a user interface for a transportation vehicle is proposed. The user interface can comprise, for example, a display screen, in particular, also a touch-sensitive surface or other types of input elements. An evaluation unit (cf. third disclosed embodiment) and a data input, which can be designed as a bus node, mobile radio and/or network module, are other essential components of the disclosed user interface for the transportation vehicle. The evaluation unit is configured to establish a data communication connection to a user terminal and/or to a stationary server by the data input. This data communication connection can be wireless and/or wired. At a later time or in response thereto, the evaluation unit receives a dataset which is created using an application of a user terminal, which defines a visual and/or functional target representation of the user interface. The evaluation unit is configured to set up a screen view and/or a functionality of the user interface in accordance with the representation of the user interface. In this way, the user interface according to the fourth disclosed embodiment also implements the features, feature combinations and benefits of the first two disclosed embodiments in such an obviously similar way that to avoid repetition, reference is made to the above comments.

According to a fifth disclosed embodiment, a computer program product (e.g., a data memory) is proposed, on which instructions are stored that enable a programmable processor/evaluation unit of an above-mentioned user interface to carry out the operations of a method in accordance with one of the two first-mentioned embodiments. The computer program product can be implemented as a CD, DVD, Blue-Ray disc, flash memory, hard disk, RAM /ROM, cache, etc.

According to a sixth disclosed embodiment, a signal sequence is proposed, which represents instructions that enable a programmable processor/evaluation unit of an above-mentioned user interface to carry out the operations of a method in accordance with one of the two first-mentioned embodiments. In this way, the information-technology based provision of the instructions is also protected for the case where the necessary storage resources are outside the scope of the attached claims.

Finally, according to a seventh disclosed embodiment, a transportation vehicle (for example, a car, a mini-van, truck, motorcycle, water-borne and/or airborne vehicle) is proposed, which has a user interface in accordance with the fourth disclosed embodiment. With regard to the features, feature combinations and benefits of the disclosed transportation vehicle also, the above comments are referenced again to avoid repetitions.

In the text which follows, to further illustrate the present disclosure, individual embodiments, examples, features, feature combinations and benefits are discussed without restrictive effect on the protected subject matter of the disclosure.

A vehicle infotainment system and a vehicle/network infrastructure are proposed, which enables a user to manage functionalities (including apps) across different platforms. Currently, there are various device or operating system-dependent portals/Appstores in which users manage their respective apps; for example, iPhone apps in the APPLE® Store, an Android television with app functionality in the Appstore of the television manufacturer, a home security system via an app/website of the manufacturer, a smart-home controller (incorporating lighting, heating and roller blind control, etc.) via the app/website of the manufacturer, additional vehicle functions via the appstore of the vehicle manufacturer, a parking, hotel, taxi app etc. These examples are intended to show that the user must cope with a variety of different appstores or management platforms. A backend/portal is proposed, by way of which the user is identifiable, e.g., via an ID. The user registers their devices and apps in this portal. Alternatively, via this common portal the user logs into other portals or services (e.g., Appstore, Android PlayStore, Amazon Prime, OEM vehicle-Appstore). The common portal is therefore aware of the user's behavior on and from all devices/services. The last usage of a service or device is also known.

If, for example, the user reads the latest news on his/her mobile phone and then opens his/her vehicle, the vehicle infotainment system automatically logs into the common portal and retrieves the current usage data. On the infotainment screen in the vehicle, the user then immediately receives the same, similar or more detailed information. If, for example, the user searches on his/her tablet computer at home for the opening times of the local library, then the library is offered as a destination for the navigation system in the vehicle, or in the case of a predictive navigation this is adopted first as a destination with high probability.

On the vehicle's infotainment system, the user can obtain an overview of their apps on the different systems via the common portal, i.e., the user sees his/her vehicle apps, mobile phone apps, smart home apps, etc. These can additionally be grouped intelligently, i.e., depending on the situation the user might not need a detailed overview of their apps on their smart TV.

Since the respective data of all apps and services are also brought together in the common portal, on entering their vehicle the user receives the following information, for example:

The light is on in the basement. Options: Switch off?-Leave on?

A window is still open. Options: Close?-Leave open?

Activate the home alarm system, surveillance cameras are switched on, heating temperature is lowered to 20°.

Should the music that was listened to on the smartphone before getting in the vehicle be continued on the upcoming journey? Options: Yes-No.

Destination: City Library—Should a charging column be reserved for the arrival time? Yes-No?

Since the user is logged into a social network site (for example, Facebook) at home on a tablet computer via their cell phone and via another app is monitoring the latest stock prices:

Display current Facebook feed and stock prices?

After the journey, the smartphone can continue to offer access and information to the vehicle, or the functions and services in the vehicle can be managed and extended:

How long has the vehicle been parked in the parking garage and what charges have been incurred?

What is the condition of the vehicle (tire pressure, charge status, etc.)?

Which settings are connected to my profile? Change the Profile settings

Which apps will be suggested to me? Set downloading of apps to the backend, hence availability of the apps in both the infotainment system in the vehicle and on smart devices

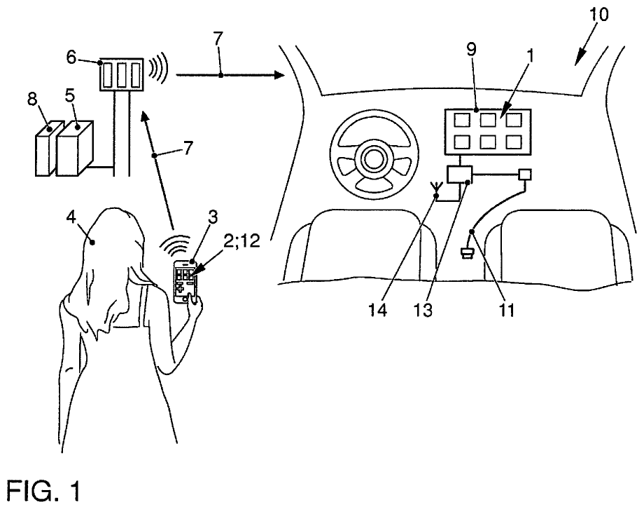

FIG. 1 shows a user 4, who would like to manipulate the configuration of a user interface 1 of a car 10 using a smartphone 3, as an exemplary embodiment of a user terminal according to the third disclosed embodiment. By using the touchscreen 12 as a user interface of the smartphone 3, the user 4 defines a visual appearance of a representation 2 of a home screen of the car 10. In other words, by drag/drop gestures she adds icons representing applications to a predefined region of the representation 2 and manipulates the relative arrangement of the application icons. The user 4 then sends a dataset defining the representation 2 via a wireless communication link 7 to a transmitting mast 6, which is connected for information transfer purposes to a server 5 of the manufacturer of the car 10 and to an application server 8 of a manufacturer of the operating system of the user interface 1. At this time the car 10 does not maintain a wireless communication link 7 with the transmitting mast 6. This is due to the fact that the user 4 is not currently accessing the car 10, which is therefore in a resting state/dormant state. Only in the course of a subsequent journey with the car 10 does the user 4 access the car 10 and its on-board electrical system. The on-board electrical system of the car 10 wakes up and logs into the transmitter mast 6 via a wireless communication link 7. This queries the manufacturer's server 5 as to whether or not in the meantime the user 4 has defined an updated representation 2 of the user interface 1. While the car 10 was “offline”, the application server 8 informed the server 5 that the user, whom it has associated with a profile stored on the server 5 via an ID stored in the smartphone 3, has sent a modified dataset defining a representation 2 of the user interface 1. In response to this the transmitter mast 6 sends the dataset from the application server 8 to an antenna 14 of the car 10, the dataset being authorized on the basis of the profile of the user 4 on the server 5. To this end, a comparison can be carried out in an electronic control unit 13 against a predefined reference/ID of the user 4 and in response thereto, the appearance of the user interface 1 on the screen 9 and its set of functions can be adjusted according to the dataset. For example, a wireless communication link made abroad between the smartphone 3 and a transmitter mast 6 can incur costs or may be completely impossible (roaming disabled). To enable a configuration according to the disclosure of the user interface in accordance with the dataset, a USB cable 11 can be used to transmit the dataset by cable to the electronic control unit 13, and therefore to manipulate the visual design as well as the functionality of the user interface 1.

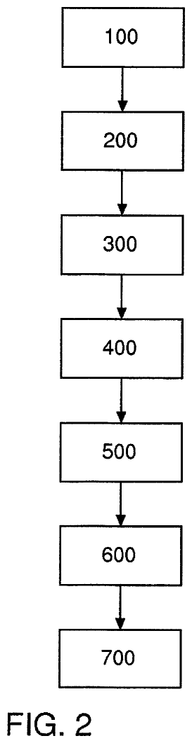

FIG. 2 shows operations of at least one exemplary embodiment of a disclosed method for configuring a user interface of a transportation vehicle. In operation at 100, a user input is determined for the offline configuration of a visual representation of the user interface of the transportation vehicle by a mobile user terminal. In operation at 200, a data communication connection of the transportation vehicle is determined between the user terminal and the transportation vehicle. In operation at 300, an authorization for an application used by the user to configure the representation is ascertained. If the authorization test is positive, in operation at 400 a dataset created using an application of the user terminal and representing a visual representation of the user interface is received, and in operation at 500 the user interface of the transportation vehicle is configured in accordance with the representation/dataset of the user interface. In operation at 600, a data communication connection is established between the transportation vehicle and an application server, and in response thereto in operation at 700 an application defined in the representation is loaded into the transportation vehicle via the data communication connection. In this way, applications corresponding to each other both on the user's terminal and on the user interface of the transportation vehicle are ready for use, although copying the application from the smartphone onto the transportation vehicle is not possible (e.g., due to different operating systems). In addition, different hardware/user interfaces may be available for user terminals and transportation vehicle, which require different operating concepts and functionalities for corresponding applications.

### LIST OF REFERENCE NUMERALS

1 user interface
2 representation
3 smartphone
4 user
5 (stationary) server
6 transmission mast
7 data communication connection
8 application server
9 display screen
10 car
11 USB cable
12 user interface (of the smartphone)
13 electronic control unit
14 antenna
100-700 method operations

1. A method for configuring a user interface of a transportation vehicle, the method comprising:
determining a user input for configuring a representation of the user interface of the transportation vehicle by a user terminal;
establishing a data communication connection between the user terminal and the transportation vehicle and/or between the user terminal and a server; and
configuring the user interface of the transportation vehicle in accordance with the representation of the user interface.

2. A method for configuring a user interface of a transportation vehicle by means of a user terminal by a user, the method comprising:
establishing a data communication connection of the transportation vehicle to a user terminal and/or to a server;
receiving a dataset created using an application of a user terminal, which represents a representation of the user interface; and
configuring the user interface of the transportation vehicle in accordance with the representation of the user interface.

3. The method of claim 1, further comprising:
determining a permission of an application used by the user for configuring the representation; and/or
establishing the data communication connection between the user terminal and the transportation vehicle via an access to a web portal logically linked to the transportation vehicle; and
configuring the user interface of the transportation vehicle.

4. The method of claim 1, wherein the configuration of the user interface comprises:
an arrangement of the applications on the home screen and/or
a definition of applications to be downloaded.

5. The method of claim 1, further comprising:
establishing a data communication connection between the transportation vehicle and an application server and in response thereto
loading an application defined in the representation via the data communication connection into the transportation vehicle.

6. The method of claim 1, further comprising:
uploading a dataset defining the representation to a stationary server by the user terminal;
terminating a data communication connection between the user terminal and the server;
setting up a second data communication connection between the server and the transportation vehicle; and
downloading the dataset from the server to the transportation vehicle.

7. The method of claim 1, wherein the transportation vehicle is in the customer's possession.

8. A user terminal for configuring a user interface of a transportation vehicle, the user terminal comprising,
a user interface;
an evaluation unit; and
a transmitter/receiver unit, wherein
the evaluation unit, in connection with the user interface, determines a user input into an application for configuring a representation of a user interface of the transportation vehicle, and
the evaluation unit, in connection with the transmitter/receiver unit, sets up a data communication connection
with the transportation vehicle and/or
with a stationary server
for transmitting a dataset defining the representation and
to transmit the dataset.

9. A user interface for a transportation vehicle, the user interface comprising:
a display screen;
an evaluation unit; and
a data input, wherein
the evaluation unit is configured,
using the data input, to establish a data communication connection to a user terminal and/or to a stationary server, and
to receive a dataset created using an application of a user terminal, which represents a representation of the user interface and
the evaluation unit is configured for setting up a screen layout and/or a set of functions in accordance with the representation of the user interface.

10. A computer program product comprising instructions, which
cause the evaluation unit to execute a method for configuring a user interface of a transportation vehicle, the method comprising:
determining a user input for configuring a representation of the user interface of the transportation vehicle by a user terminal;
establishing a data communication connection between the user terminal and the transportation vehicle and/or between the user terminal and a server; and
configuring the user interface of the transportation vehicle in accordance with the representation of the user interface when the instructions are executed on an evaluation unit for configuring a user interface of a transportation vehicle, the user terminal comprising,
a user interface;
an evaluation unit; and
a transmitter/receiver unit, wherein
the evaluation unit, in connection with the user interface, determines a user input into an application for configuring a representation of a user interface of the transportation vehicle, and
the evaluation unit, in connection with the transmitter/receiver unit, sets up a data communication connection
with the transportation vehicle and/or
with a stationary server
for transmitting a dataset defining the representation and
to transmit the dataset or
cause the evaluation unit to execute a method for configuring a user interface of a transportation vehicle by a user terminal by a user, the method comprising:
establishing a data communication connection of the transportation vehicle to a user terminal and/or to a server;
receiving a dataset created using an application of a user terminal, which represents a representation of the user interface; and
configuring the user interface of the transportation vehicle in accordance with the representation of the user interface when the instructions are executed on an evaluation unit of a user interface for a transportation vehicle, the user interface comprising:
a display screen;
an evaluation unit; and
a data input, wherein
the evaluation unit is configured,
using the data input, to establish a data communication connection to a user terminal and/or to a stationary server, and
to receive a dataset created using an application of a user terminal, which represents a representation of the user interface and
the evaluation unit is configured for setting up a screen layout and/or a set of functions in accordance with the representation of the user interface.

11. A signal sequence representing instructions, which
cause the evaluation unit to execute a method for configuring a user interface of a transportation vehicle, the method comprising:
determining a user input for configuring a representation of the user interface of the transportation vehicle by a user terminal;
establishing a data communication connection between the user terminal and the transportation vehicle and/or between the user terminal and a server; and
configuring the user interface of the transportation vehicle in accordance with the representation of the user interface when the instructions are executed on an evaluation unit for configuring a user interface of a transportation vehicle, the user terminal comprising,
a user interface;
an evaluation unit; and
a transmitter/receiver unit, wherein
the evaluation unit, in connection with the user interface, determines a user input into an application for configuring a representation of a user interface of the transportation vehicle, and
the evaluation unit, in connection with the transmitter/receiver unit, sets up a data communication connection
with the transportation vehicle and/or
with a stationary server
for transmitting a dataset defining the representation and
to transmit the dataset or
cause the evaluation unit to execute a method for configuring a user interface of a transportation vehicle by a user terminal by a user, the method comprising:
establishing a data communication connection of the transportation vehicle to a user terminal and/or to a server;
receiving a dataset created using an application of a user terminal, which represents a representation of the user interface; and
configuring the user interface of the transportation vehicle in accordance with the representation of the user interface when the instructions are executed on an evaluation unit (13) of a user interface (1) for a transportation vehicle, the user interface comprising:
a display screen;
an evaluation unit; and
a data input, wherein
the evaluation unit is configured,
using the data input, to establish a data communication connection to a user terminal and/or to a stationary server, and
to receive a dataset created using an application of a user terminal, which represents a representation of the user interface and
the evaluation unit is configured for setting up a screen layout and/or a set of functions in accordance with the representation of the user interface.

12. A means of transport comprising a user interface for a transportation vehicle, the user interface comprising:
a display screen;
an evaluation unit; and
a data input, wherein
the evaluation unit is configured,
using the data input, to establish a data communication connection to a user terminal and/or to a stationary server, and
to receive a dataset created using an application of a user terminal, which represents a representation of the user interface and
the evaluation unit is configured for setting up a screen layout and/or a set of functions in accordance with the representation of the user interface.
